(19) United States
(12) Patent Application Publication
(10) Pub. No.: US 2014/0231435 A1
(43) Pub. Date: Aug. 21, 2014

(54) Attachment Device

(71) Applicant: Rich McCabe, Apple Valley, MN (US)

(72) Inventor: Rich McCabe, Apple Valley, MN (US)

(73) Assignee: Rich McCabe, Apple Valley, MN (US)

(21) Appl. No.: 14/178,754

(22) Filed: Feb. 12, 2014

Related U.S. Application Data
(60) Provisional application No. 61/766,842, filed on Feb. 20, 2013.

(51) Int. Cl. B65F 1/06

(52) U.S. Cl. CPC B65F 1/06
USPC 220/495.08

(57) ABSTRACT

An attachment device includes an expandable element, the expandable element having a first end, a retaining element engaged to the first end, an elongate portion, a tubular element in surrounding engagement to at least a portion of the elongate portion, a looped end, and a grasping element engaged to the looped end. The tubular element may be disposed between the retaining element and the grasping element. The attachment device is constructed and arranged to releasably secure a liner within a receptacle.

### CROSS REFERENCE TO RELATED APPLICATIONS

This application claims the benefit of provisional patent application Ser. No. 61/766,842 filed on Feb. 20, 2013 which is incorporated herein by reference in its entirety.

### BACKGROUND OF THE INVENTION

In the past individuals have used waste receptacle liners with waste receptacles for a number of reasons including but not limited to cleanliness, ease-of-use, sanitation, and obnoxious older reduction to name a few.

In the past the engagement and retention of a waste receptacle liner within a waste receptacle has been problematic. The liners as known may be disposed within the interior of a waste receptacle and opened, where the top of the liner is folded over the top of the receptacle adjacent the receptacle upper lip. The bottom of the liner may be positioned above the base or bottom of the waste receptacle within the interior of the receptacle. Frequently, the upper portion of a waste receptacle liner as folded over the lip of a waste receptacle would disengage or separate from the lip during the filling of the liner with waste. Deposit of waste into the liner/receptacle may then cause the entire liner to descend into the waste receptacle causing the top of the liner to separate from the lip. The top portion of the waste receptacle liner would frequently descend into the interior of the waste receptacle and at least partially fold over upon itself, which in turn would at least partially close the opening to the waste receptacle liner, reducing ease-of-use. In the past individuals would then reposition the top of the waste receptacle liner over the lip of the waste receptacle, only to have the attachment of the waste receptacle liner to the lip of the waste receptacle fail prior to the filling of the waste receptacle liner.

The premature failing of the engagement of the waste receptacle liner to the lip of the waste receptacle increased the expense to an individual, reduced convenience, consumed time resources, and lowered the overall utility of a waste receptacle. No device was previously known which simply and easily facilitated the engagement and retention of a waste receptacle liner to the exterior edge or lip of a waste receptacle.

### BRIEF DESCRIPTION OF THE DRAWINGS

FIG. 1 is an environmental view of one embodiment of a container used in association with one embodiment of an attachment device.

FIG. 2 is an alternative environmental partial cut away view of one embodiment of a container and one embodiment of an attachment device.

FIG. 3 is an alternative environmental view of one embodiment of a container and one embodiment of an attachment device.

FIG. 4 is an alternative environmental view of one embodiment of a container and one embodiment of an attachment device.

FIG. 5 is an isometric view of at least one embodiment of an attachment device.

FIG. 6 is an alternative environmental view of at least one embodiment of a container including a liner and one embodiment of an attachment device in an unengaged position.

FIG. 7 is an alternative environmental view of at least one embodiment of a container including a liner and one embodiment of an attachment device in an engaged position.

FIG. 8 is an alternative environmental view of at least one embodiment of a container including a liner and one embodiment of an attachment device in an engaged position.

### BRIEF SUMMARY OF THE INVENTION

The attachment device is designed to secure a waste receptacle liner which is inserted into a container or waste receptacle, which in turn is used for the deposit of waste, so that the liner does not disengage from the top or lip of the waste receptacle or container and descend into the container or waste receptacle.

The attachment device used to secure a waste receptacle liner to a waste receptacle in some embodiments may be formed of an expandable element, a tubular element, a retaining element, and a grasping element. The expandable element may have looped end, and loose ends which may be joined together by a knot or other mechanical device. The looped end of the expandable element may be passed through the retaining element and the tubular element. A handle or grasping element may also be attached to the looped end of the expandable element.

In at least one embodiment, the loose ends of the expandable element are secured together by a knot or other mechanical fastening element forming the first end. The looped end is opposite to the first end and is inserted through the retaining element. The looped end may then be passed through an aperture through the wall of a waste receptacle or container from the interior of the waste receptacle outwardly. The looped end may then be inserted through the tubular element and a grasping element may be attached to the looped end. A receptacle liner may then be disposed within the interior of the waste receptacle or container where the upper portion of the liner is disposed/folded over the lip of the receptacle and placed adjacent to the exterior wall of the receptacle. An individual may then draw the grasping member to tension and to increase the length dimension for the expandable element in order to engage the perimeter of the receptacle below the lip, releasably securing the upper portion of the liner between the exterior wall of the receptacle and the expandable element.

The attachment device used to releasably secure a liner to a waste receptacle may in some embodiments include an expandable element releasably securing a liner within a waste receptacle; the attachment device additionally comprising a retaining member or washer engaged to the expandable element; the expandable element comprising a loop; and a grasping element engaged to the expandable element or loop. In addition, the attachment device may further comprise a tubular element in surrounding engagement to at least a portion of the expandable element. The tubular element may be disposed between the retaining element and the grasping element.

In at least one embodiment a waste receptacle may comprise a bottom, at least one wall defining an interior and an exterior, the at least one wall having a top or lip; and an aperture disposed through the at least one wall. In at least one embodiment, the expandable element is at least partially disposed through the aperture, the expandable element comprising: a retaining element disposed within the interior of the container and a grasping element disposed exterior to the at least one wall. In at least one embodiment, a tubular element is in surrounding engagement to at least a portion of the expandable element exterior to the at least one wall. In at least one embodiment the aperture may be disposed through the at least one wall proximate to the top of the container.

### DETAILED DESCRIPTION OF THE INVENTION

In at least one embodiment, the attachment device 10 is constructed and arranged to reduce the frequency of involuntary separation of a waste receptacle liner 30, as used in a waste container 28, from the rim or lip 34 of the waste container 28, and the descent of the linear 30 into the interior of the container 28 upon the deposit of waste into the waste receptacle liner 30.

In some embodiments, the looped end 20 of the attachment device 10 may be easily stretched over the upper portion of the waste receptacle 28 and over the upper portion 32 of the receptacle liner 30 which has been previously folded over the lip or rim 34 of the waste receptacle 28 in order to secure the receptacle liner 30 to the container 28. The releasable attachment of the receptacle liner 30 to the container 28 facilitates placement of items into the interior of the liner 30 and the removal of the liner 30 from the interior of the waste receptacle 28.

In some embodiments the attachment device 10 includes an expandable element 12 which is used to secure a liner 30 to a waste receptacle 28 about the exterior proximate to the top lip 34 of the waste receptacle 28. The expandable element 12 in some embodiments may be formed of an elastic cord, rubber component, or other expansible or elastic device. In some embodiments, the expandable element 12 includes a closed looped end 20 and loose ends 22. Loose ends 22 may be tied, knotted, or joined which may be identified as a first end 36. In some embodiments, the expandable element 12 is constructed and arranged to elastically expand in order to extend around the exterior periphery of the top lip 34, and then upon release of the expandable element 12 to contract, in order to pinch and/or secure the top 32 of the plastic liner 30 between the exterior wall 26 of the waste receptacle/container 28 and the expandable element 12 adjacent to the upper lip 34, thereby retaining the liner 30 in a desired location relative to the waste receptacle 28. In some embodiments, the expandable element 12 holds the top 32 of liner 30 in a desired location relative to the waste receptacle 28, therefore, items disposed into the liner 30 within the opening and within the interior of the waste receptacle 28 do not cause the top 32 of the liner 30 to release from the top of the receptacle 28, and fall into the bottom of the receptacle 28. In some embodiments, an individual using the expandable element 12 is not required to grasp or manipulate the liner 30 within the interior of the waste receptacle 28 to return the liner 30 to a position engaging the upper lip 34 of the waste receptacle 28. In some embodiments, the expandable element 12 has a looped end 20 which is opposite to a stop or a knot which is proximate to the first end 36. In some embodiments, the first end 36 is positioned adjacent to the at least one interior wall 26 for the waste receptacle 28. In some embodiments, during use, the majority of the expandable element 12 is exterior to a waste receptacle 28 for use in releasably attaching a liner 30 to the waste receptacle 28.

In some embodiments, a waste receptacle 28 may be any shape and/or size as desired, including square, rectangular, oval, or circular to name a few. In some embodiments, it is common for a waste receptacle 28 to include a bottom, at least one wall 26, a top, and opening defining an interior for the waste receptacle 28, and an upper lip 34. In general, the waste receptacle 28 is constructed and arranged for holding waste and may be commonly located within a kitchen or under a sink. In at least one embodiment an aperture 38 traverses the at least one wall 26 of the waste receptacle 28, where the aperture 38 has a smooth interior edge in order to prevent cutting or abrasion of the expandable element 12 passing there through.

In some embodiments, a grasping element 18 may be engaged to the loop end 20 of the expandable element 12 which is opposite to the first end 36. The grasping element 18 may be formed of a handle, tab, ring and/or other grasping device which acts or functions to assist an individual to grasp and to pull the expandable element 12 to releasably engage the exterior circumference of the wall 36 of a waste receptacle 28 adjacent to the top lip 34 in order to secure the liner 30 between the expandable element 12 and the exterior wall 26 of the waste receptacle 28.

In some embodiments a tubular element 14 is disposed around a portion of an elongate portion of the expandable element 12. In at least one embodiment, the tubular element 14 is located proximate to the knot or first end 36 of the expandable element 12 exterior to the wall 26 of the waste receptacle 28. In at least one embodiment the tubular element 14 assists to positioned the expandable element 12 as engaged to the exterior wall 26 of the receptacle 28. In some embodiments the tubular element 14 assists in the positioning of the expandable element 12 relative to the aperture 38 in the wall 26 of the receptacle 28. Generally, in at least one embodiment, the tubular element 14 has a sufficient diameter dimension to prevent passage through, or to become affixed or engaged to, the aperture 38 through the receptacle wall 26. In some embodiments the tubular element 14 is formed of plastic, metal, composite, or other materials or combinations thereof. In at least one embodiment, the tubular element 14 has smoothed/rounded interior edges to minimize cutting and/or abrasion of the expandable element 12.

In at least one embodiment a retaining element 16 may be engaged to the expandable element 12 opposite to the grasping element 18 and proximate to the knot and/or first end 36. The retaining element 16 may be a washer, plate, or any other device which assists to prevent separation of the expandable element 12 from the interior of the wall 26 of the waste receptacle 28, preventing the expandable element 12 from being disconnected from the wall 26 of the waste receptacle 28 during tensioning of the expandable element 12 about the perimeter of the waste receptacle 28. It should be noted that the retaining element 16 may be of any size and/or shape as desired by an individual. In at least one embodiment, the retaining element 16 includes a central opening 40, and the expandable element 12 is disposed through the central opening 40 of the retaining element 16. The central opening 40 preferably has smooth edges to reduce any cutting or abrasion of the expandable element 12 during use. In at least one embodiment, the knot or stop of the expandable element 12 also functions to prevent the expandable element 12 from being pulled through the central opening 40 of the retaining element 16. In general, the central opening 40 in the retaining element 16 is sufficiently small to prevent separation of the expandable element 12 from the retaining element 16 during use in the affixation of a liner 30 to a waste receptacle 28. In at least one embodiment, the retaining element 16 is positioned within the interior of the waste receptacle 28 and the expandable element 12 is disposed from the interior of the waste receptacle 28 to the exterior. The retaining element 16 in some embodiments prevents the expandable element 12 from being pulled to the exterior of the waste receptacle 28 to disengage the expandable element 12 from the waste receptacle 28 during use. The retaining element 16 may be formed of plastic material and may be round, square, oval, or any shape as desired. It should be noted that the retaining element 16 may also be formed of metal, composite materials, and/or combinations thereof.

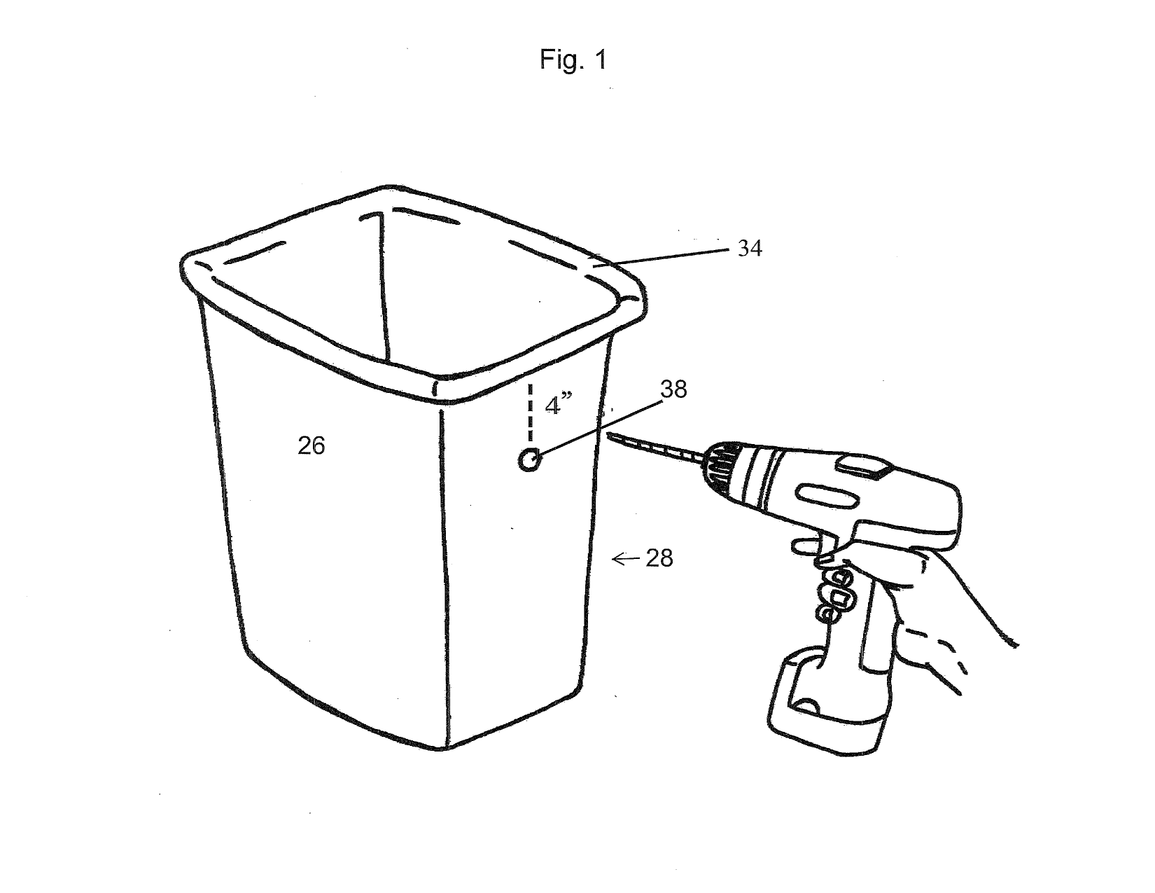

In at least one embodiment, as depicted in FIG. 1, a waste receptacle 28 is disclosed. As shown in FIG. 1 an individual may acquire a waste receptacle 28 which includes an aperture 38, or an aperture 38 may be placed through a wall 26 of the waste receptacle 28 by an individual through the use of a tool such as a hand drill. In some embodiments the interior edges of the aperture 38 have been rounded or smoothed to minimize abrasion or cutting of the expandable element 12.

In some embodiments, the aperture 38 is disposed below the lip 34 of the waste receptacle 28 by a dimension of between 1 inch and 6 inches. In other embodiments, the aperture 38 may be disposed below the lip 34 of the waste receptacle 28 by a dimension of less than 1 inch or greater than 6 inches.

In some embodiments, the size dimension for the waste receptacle 28 may vary and be of any size as desired. In some embodiments, the dimensions for the expandable element 12 may be adjusted accordingly to provide a snug fit to the exterior wall 26 of the waste receptacle 28 proximate to the lip 34.

In some embodiments, the aperture 38 also minimizes or eliminates vacuum/suction between the liner 30 and the interior wall 26 of the container 28 during the withdraw of the liner 30 from the waste receptacle 28.

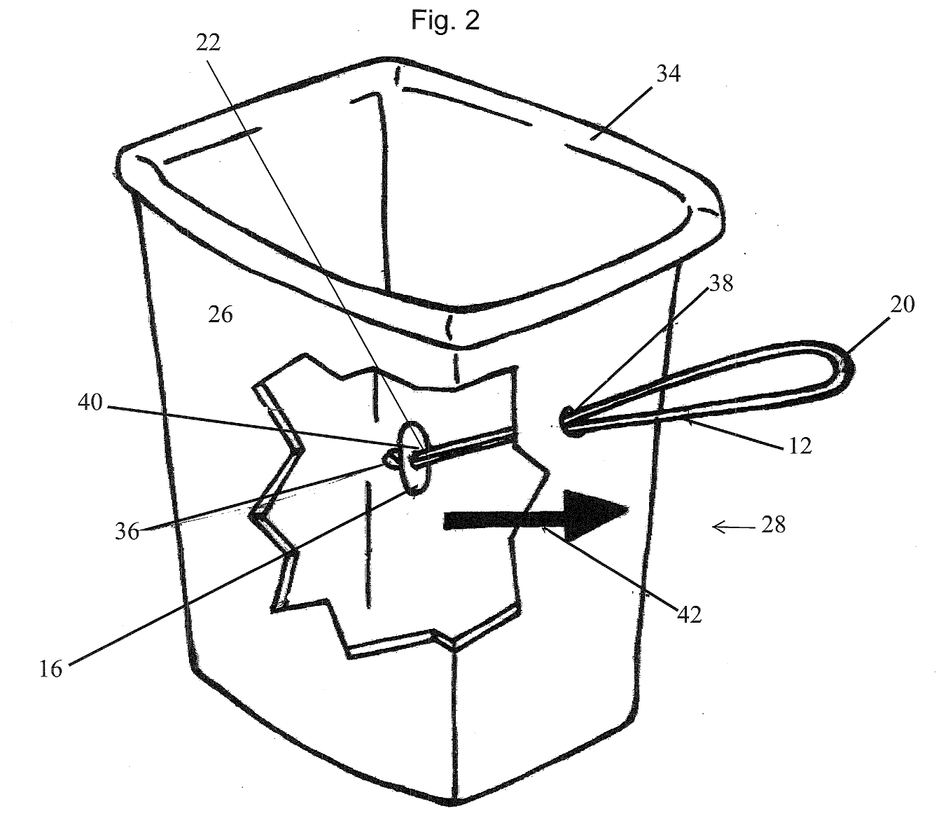

In at least one embodiment as depicted in FIG. 2, a waste receptacle 28 is shown with a partial cutaway of the wall 26 to show the interior of the receptacle 28. In the embodiment depicted in FIG. 2, the loose ends 22 of the expandable element 12 have been secured together by the tying of a knot establishing a looped end 20 opposite to a first end 36. Initially, the looped end 20 has been disposed through the central opening 40 of the retaining element 16, which in some embodiments may be a washer or other mechanical device. The retaining element 16 minimizes the inadvertent separation of the attachment device 10 from the waste receptacle 28, due to the pulling of the knot of the first end 36 through the central opening 40 and/or aperture 38. In some embodiments, the interior edges of the central opening 40 have been smoothed to minimize risk of abrasion, cutting and/or damage to the expandable element 12 as disposed through the central opening 40.

In some embodiments, the knot of the first end 36 may be sufficiently large to prevent pulling of the knot through the aperture 38, and the separation of the attachment device 10 from the waste receptacle 28. In some embodiments, the first end 36 may be double, triple, or multiple knotted.

In some embodiments, the aperture 40 in the retaining element 16 may have any dimension as desired, and in some embodiments the diameter dimension has been selected, and is at least somewhat related to, the diameter dimension selected for the expandable element 12. In some embodiments, the surface area of the retaining element 16 may be increased and/or decreased dependent upon the size of the aperture 38 in the wall 26 of the receptacle 28. In some alternative embodiments, the thickness dimension for the retaining element 16 may be sufficiently large to minimize fracture and/or failure of the retaining member 16 and/or to minimize risk of damage of the wall 26 of the receptacle 28 proximate to the aperture 38. In some embodiments the retaining element 16 has a larger dimension as compared to the aperture 38 in wall 26 to prevent the attachment device 10 and retaining element 16 from being inadvertently pulled through the aperture 38.

In some embodiments, the expandable element 12 may be formed of rubber, elastic material, may be coated, wrapped, and/or encased within and abrasion resistant or cut resistant material, provided that the elasticity of the expandable elements 12 is not adversely affected. In some embodiments, the material selected for the expandable element 12 may be moisture resistant. In other embodiments, the expandable element 12 may be treated with a moisture resistant substance.

In some embodiments, other devices or affixation mechanisms may be used to secure the first end 36 of the attachment device 10 within the interior of the waste receptacle 28 proximate to the aperture 38. In some embodiments, the first end 36 may be affixed to the interior wall 26 by adhesives, staples, or other mechanical devices to permanently affix the first end 36 to the wall 26. In other embodiments other devices and/or affixation mechanisms may be utilized to releasably secure the first end 36 to the interior of the wall 26.

In some embodiments, the wall 26 of the receptacle 28 may include a depression or recess to accommodate receipt of the retaining element 16. In other embodiments, the retaining element 16 is smooth and/or relatively flat to minimize risk of engagement, penetration of, and/or tearing of the receptacle liner 30 during withdraw of the liner 30 from the waste receptacle 28.

In some embodiments, the diameter of the expandable element 12 will vary and be of any dimension as desired. In other embodiments, the expandable element 12 may be formed of the same or different colored materials, or may be colored to match or to contrast with the colors of an environment.

In some embodiments, as depicted by arrow reference numeral 42 of FIG. 2 the looped end 20 of the expandable element 12 is drawn from the interior of the waste receptacle 28 to the exterior.

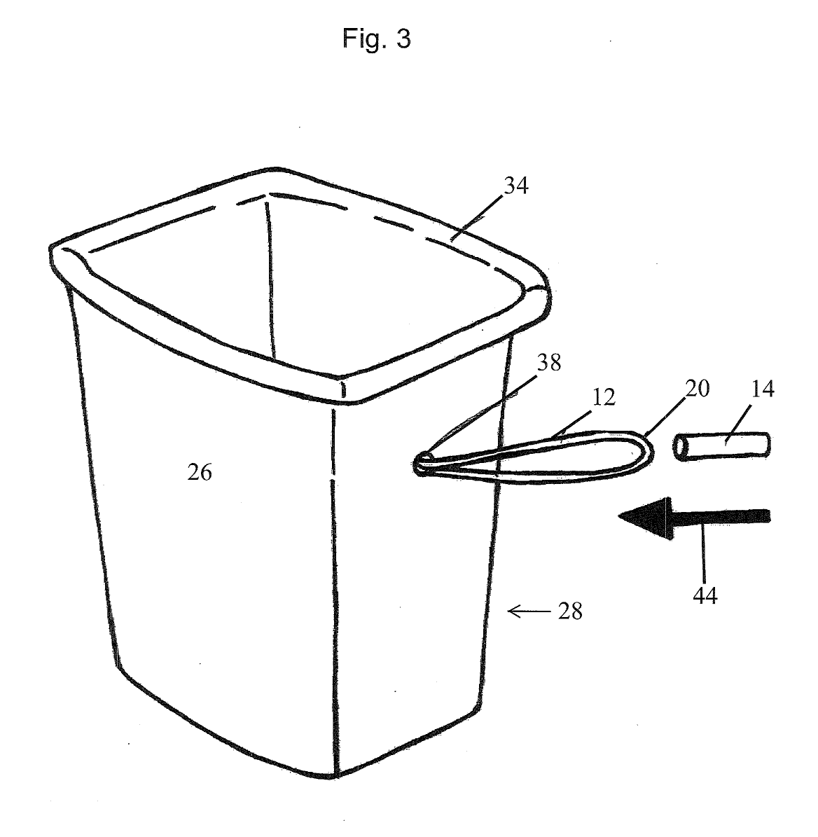

In at least one embodiment as depicted in FIG. 3, a tubular element 14 is disposed over the looped end 20 of the expandable element 12 as shown by arrow 44 of FIG. 3. In some embodiments, the diameter of the tubular element 14 will vary dependent on the size of the expandable element 12. In some embodiments, the length of the tubular element 14 will vary dependent upon the circumference dimension of the receptacle 28 and/or the location of the aperture 38 relative to the lip 34. For example, the length dimension of the tubular element 14 may be increased as the distance dimension between the lip 34 and the aperture 38 increases. Conversely, the length dimension for the tubular element 14 may decrease as the distance dimension between the lip 34 and the aperture 38 decreases.

In some embodiments, the tubular element 14 functions to provide a horizontal and substantially parallel positioning of the expandable element 12 relative to the lip 34 to increase the area of contact between the expandable element 12 and the upper portion 32 of the liner 30 (FIG. 7).

In contrast, in certain embodiments where the tubular element 14 is omitted, then the expandable element 12, as drawn for circumferential engagement to the exterior wall 26 of the receptacle 28, will primarily engage the upper portion 32 of the liner 30 on three sides of a rectangular receptacle 28, and will have reduced contact with the liner 30 proximate to the aperture 38 (FIG. 8). The reduction of contact between the expandable element 12 and the liner 30 will occur because the upper portion 32 of the liner 30 may not be positioned downwardly below the level of the aperture 38.

In some embodiments, the aperture 38 represents the lowest point for the positioning of the upper portion 32 of the liner 30 relative to the exterior of the receptacle 28. Therefore, the expandable element 12 when placed into an operative engaged position relative to the liner 30 and receptacle 28, will likely position the portion of the expandable element 12 proximate to the aperture 38 at a reduced elevation relative to the lip 34.

In some embodiments the reduced contact between the expandable element 12 and the liner 30 proximate to the aperture 38 will result in an increased frequency of separation of the liner 30 from the receptacle 28 when items are placed or disposed within the interior of the liner 30 (FIG. 8).

In contrast, in some embodiments, the tubular element 14 is positioned for contact with the liner 30, where the tubular element 14 extends upwardly from the aperture 38 towards the lip or rim 34 of the receptacle 28 (FIG. 7). In this embodiment, the use of the tubular element 14 facilitates the horizontal or parallel positioning of the expandable element 12 relative to the lip 34, maximizing the surface area of contact between the expandable element 12 and the upper portion 32 of the liner 30. The increased surface area contact between the expandable element 12 and the liner 30 reduces the likelihood that the liner 30 will inadvertently separate from the receptacle 28 during deposit of items within the liner 30.

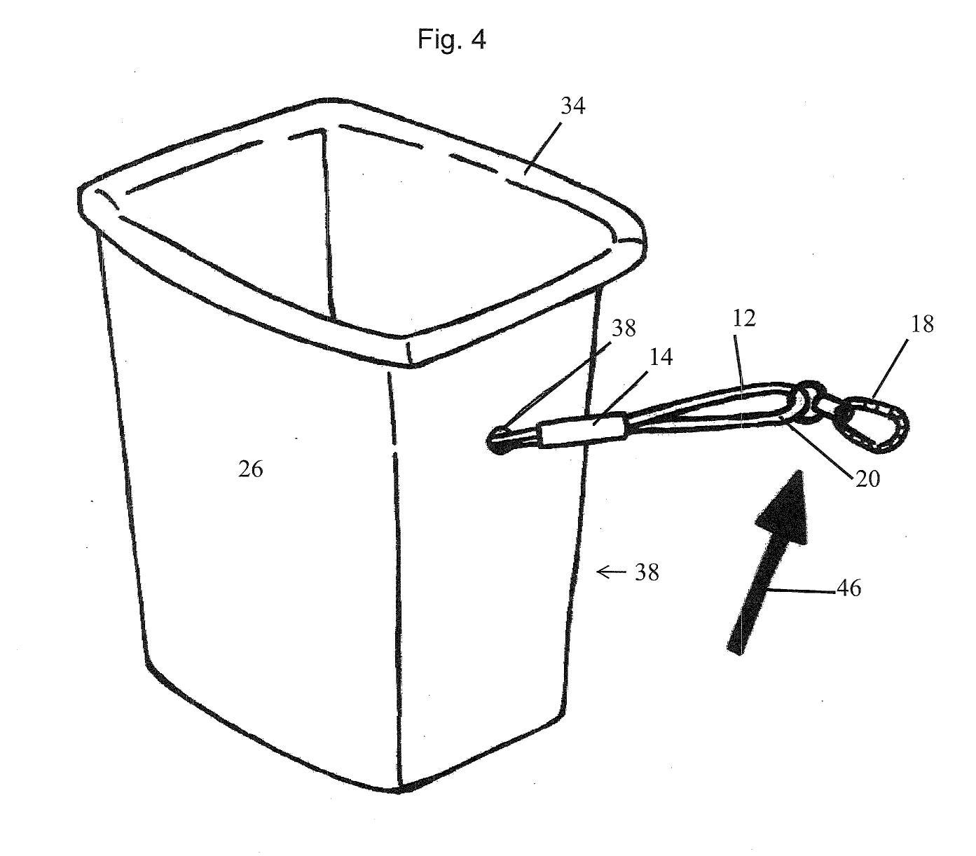

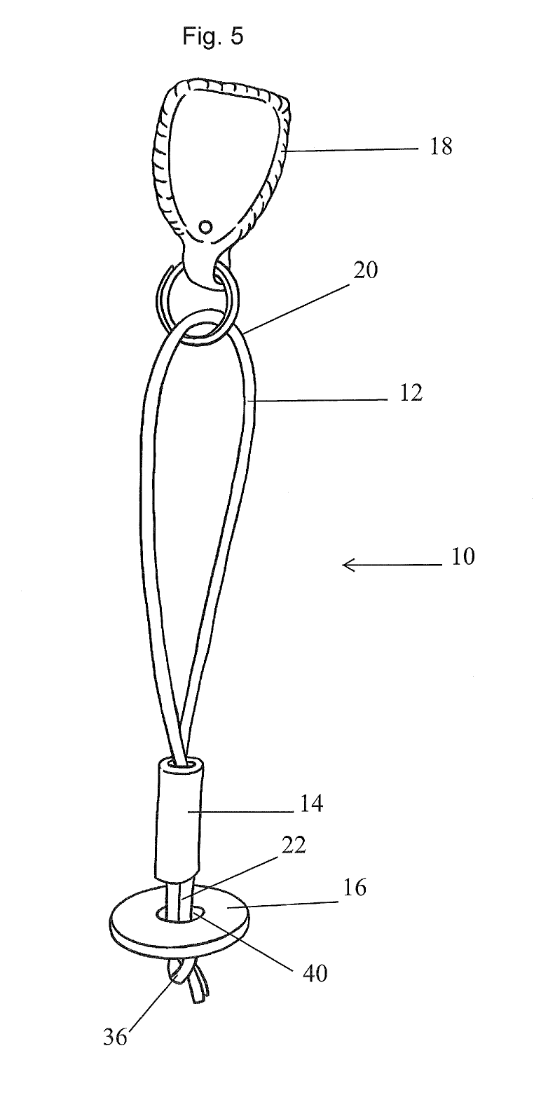

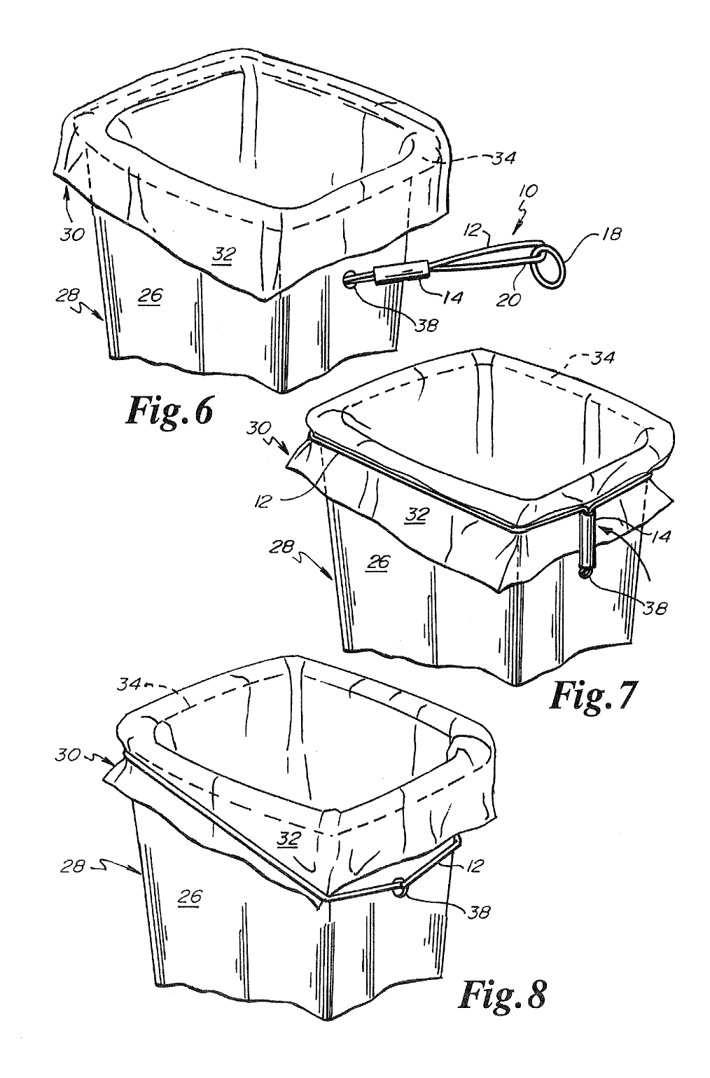

In at least one embodiment as depicted by arrow 46 of FIG. 4 a ring has been utilized to engage the handle or grasping element 18 to the looped end 20. In at least one embodiment, the handle or grasping element 18 is engaged to the looped end 20 after the looped end 20 has passed through the tubular element 14. In some embodiments the handle or grasping element 18 will be either releasably or permanently engaged to the expandable element 12. In some embodiments, the handle or grasping element 18 will be directly attached to the expandable element 12, and in other embodiments, an intermediate device such as a ring may be utilized. In some alternative embodiments, the handle or grasping element 18 may be of any type of mechanical device which may be easily grasped and pulled to initiate the elastic expansion of the expandable element 12 to draw the expandable element 12 for placement about the circumference of a container 28 proximate to a lip or rim 34.

In some alternative embodiments, a grasping element or handle 18 is not required to be utilized with, or engaged to, the expandable element 12. In some embodiments, an individual may grasp the looped end 20 directly, for expansion and placement about the circumference of a container wall 26 and over the upper portion 32 of the liner 30, to secure the liner 30 to the receptacle 28.

In some embodiments, the handle 18 may be a loop, circle, oval, ring, T-shape, or other desired configuration to facilitate grasping and manipulation by an individual. In some embodiments, the handle or grasping element 18 may be releasably attached to the expandable element 12, and may be removed from the expandable element 12 following. In some embodiments, the handle or grasping element 18 is permanently affixed to the expandable element 12.

In some embodiments, if the expandable element 12 becomes cut, worn, or soiled, then the attachment device may be easily replaced by removal of the handle or grasping element 18 from the looped end 20. Next, the tubular member 14 may be removed from the looped end 20 and the looped end 20 may be drawn into the interior of the receptacle 28 through the opening 38. In a next step, the looped end 20 may be withdrawn from the central opening 40 of the retaining element 16. In some embodiments, the elements of the retaining element 16, tubular element 14 and grasping element 18 may be reused in association with a replaced expandable element 12. In some embodiments the expandable element 12 may be replaced in the event that the elasticity performance for the expandable element 12 degrades.

In some embodiments, the assembly of the attachment device 10 to the receptacle 28 occurs by the initial acquisition/selection of the expandable element 12. The loose ends 22 may in some embodiments be knotted to form the first end 36 and the looped end 20. The looped end 20 may then be inserted through the central opening 40 of the retaining element 16. The looped end 20 may then be passed through the opening/aperture 38 through the wall 26 of the receptacle 28. The looped end 20 may then be passed through the center of the tubular element 14 whereupon the handle/grasping element 18 may be attached to the looped end 20.

A liner 30 may then disposed inside the receptacle 28 where the upper portion 32 is positioned proximate to the lip or rim 34. The upper portion 32 is then manipulated outwardly and downwardly to completely cover the lip or rim 34 placing the upper portion 32 adjacent to the exterior wall 26 of the receptacle 28 in the space between the horizontal level of the opening 38 and the lip or rim 34.

In some embodiments, an individual then grasps the handle 18 and pulls the handle towards the opposite side of the receptacle 28 relative to the opening 38. The elasticity of the expandable element 12 permits a portion of the expandable element 12 to be positioned and disposed proximate to the circumferential sides of the receptacle 28 over the upper portion 32 of the liner 30 (FIG. 7). Simultaneously, the tubular element 14 extends upwardly from the opening 38 towards the lip or rim 34 facilitating the positioning of the expandable element 12 substantially horizontal and parallel to the lip or rim 34. The handle 18 is then drawn to the opposite side of the container 28 whereupon it is released. The elastic expandable element 12 then contracts to dispose the expandable element 12 about the entire circumference of the receptacle 28 exerting continuous and constant inward pressure to releasably secure the upper portion 32 of the liner 30 against the exterior wall 26 of the receptacle 28 above the level of the opening 38. The liner 30 then has an open top which may be used to receive items to be placed within the receptacle 28.

In some embodiments, when the liner 30 and the receptacle 28 have been filled with items to a desired level, then an individual may grasp the handle 18 and expand the expandable element 12 where the handle 18 may be manipulated upwardly to separate the expandable element 12 from the exterior wall 26 of the receptacle 28 and disengage the expandable element 12 from the upper portion 32 of the liner 30. In individual may then release the handle 18 allowing the attachment device 10 to become slack. An individual may then grasp the upper portion 32 of the liner 30 and vertically withdraw the liner 30 and the held items from the interior of the receptacle 28.

In addition to being directed to the embodiments described above and claimed below, the present invention is further directed to embodiments having different combinations of the dependent features described above and/or claimed below.

Every patent, application or publication mentioned above is herein incorporated by reference.

The invention contemplates any combination of the above described elements of the stringed instrument. Therefore, it should be understood that multiple inventions are disclosed herein.

The above examples and disclosure are intended to be illustrative and not exhaustive. These examples and description will suggest many variations and alternatives to one of ordinary skill in this art. Further, the particular features presented in the dependent claims can be combined with each other in other manners within the scope of the invention such that the invention should be recognized as also specifically directed to other embodiments having any other possible combination of the features of the dependent claims.

This completes the description of the alternate embodiments of the invention. Those skilled in the art may recognize other equivalents to the specific embodiment described herein which equivalents are intended to be encompassed by the claims attached hereto.

I claim:

1. An attachment device comprising:
an expandable element, said expandable element comprising a first end, an elongate portion and a looped end;
a tubular element in surrounding engagement to at least a portion of said elongate portion; and
a grasping element engaged to said looped end.

2. The attachment device according to claim 1, further comprising a retaining element engaged to said first end.

3. The attachment device according to claim 2, wherein said tubular element is disposed between said retaining element and said grasping element.

4. The attachment device according to claim 3, said expandable element comprising at least two loose ends being engaged to each other to form said first end.

5. The attachment device according to claim 4, said first end comprising a knot.

6. The attachment device according to claim 4, said retaining element comprising a central opening, said central opening receiving a portion of said expandable element proximate to said first end.

7. The attachment device according to claim 4, wherein said attachment device is constructed and arranged to releasably secure a liner to a receptacle.

8. The attachment device according to claim 7, said receptacle comprising: a bottom, at least one wall defining an interior and an exterior, said at least one wall comprising a lip and an aperture disposed through said at least one wall below said lip, wherein at least a portion of said expandable element is disposed through said aperture.

9. The attachment device according to claim 8, wherein said first end and said retaining element are disposed adjacent to said aperture within said interior.

10. The attachment device according to claim 9, wherein said tubular element is disposed adjacent to said aperture exterior to said at least one wall.

11. The attachment device according to claim 10, wherein said elongate portion, said looped end, said tubular element and said grasping element are disposed to the exterior of said at least one wall.

12. The attachment device according to claim 11, said liner comprising an upper portion, said liner being disposed within said interior of said receptacle and said upper portion being in contact with and extending from said interior over said lip, at least a portion of said upper portion being disposed proximate to said exterior of said at least one wall.

13. The attachment device according to claim 12, wherein said attachment device has an engaged position and an unengaged position, in said engaged position said tubular element extends upwardly from a position proximate to said aperture toward said lip engaging a portion of said upper portion between said tubular element and said exterior of said at least one wall.

14. The attachment device according to claim 13, wherein said grasping element is manipulated to place said attachment device in said engaged position further wherein said elongate portion is disposed about a circumference of said at least one wall below said lip engaging a portion of said upper portion between said expandable element and said exterior of said at least one wall.
